(19) United States
(12) Patent Application Publication
(10) Pub. No.: US 2026/0368074 A1
(43) Pub. Date: Nov. 19, 2026

(54) STATIC ANALYSIS FOR UNIX SHELL PROGRAMS

(71) Applicant: Brown University, Providence, RI (US)

(72) Inventor: Nikos Vasilakis, Boston, MA (US)

(21) Appl. No.: 19/677,333

(22) Filed: May 14, 2026

(30) Foreign Application Priority Data
May 14, 2025 (GR) 20250100363

(51) Int. Cl. G06F 11/3668

(52) U.S. Cl. CPC G06F 11/3688

(57) ABSTRACT

Systems and methods are disclosed for semantics-driven analysis of Unix shell functionality. A shell script is analyzed by generating constraints on program state, including file system effect constraints and stream content constraints. The constraints may be expressed using logical preconditions and postconditions for command effects and regular languages for streams. A symbolic execution engine simulates shell semantics and propagates the constraints across possible executions. Command specifications are applied to model effects of command invocations, including effects of black-box commands. In some implementations, command specifications are inferred from documentation and validated using instrumented probing to build a specification library. Specification-aware runtime monitoring may be implemented to halt execution upon detecting a potential error or unsafe determination of the Unix shell.

### GOVERNMENT LICENSE RIGHTS

This patent application was made with government support under grant numbers CNS-2247687 and CNS-2312346 awarded by the National Science Foundation and contract number HR001124C0486 awarded by the Defense Advanced Research Projects Agency. The government has certain rights in this application.

### CROSS REFERENCE TO RELATED APPLICATIONS

The instant application claims priority from Greek patent application No. 20250100363, filed May 14, 2025, the disclosure of which is incorporated herein by reference.

### BACKGROUND

Shell programming is a prevalent yet complex programming approach. The complexities of shell programming arise due to the structure of shell programs, their use of black-box software components, and intricate and detailed interactions with broader environments. As a result, even when exercising attention and caution, shell developers often find significant bugs in their programs at runtime. At best, shell programs with such errors crash the execution of a long-running task. At worst, shell programs with errors silently corrupt a broader environment in which the shell programs affect user data, unintentionally modify system files, and render entire systems unusable. Thus there is a need for improved programming and system analysis for shell programming.

### SUMMARY

Example systems, methods, and apparatus are disclosed herein for static analysis for Unix shell programs. Examples disclosed herein provide methods for shell users to benefit from ahead-of-time analyses by combining several insights. One example disclosed herein includes a “divide and conquer” approach including disaggregating static guarantees into tractable subclasses, developing separate subsystems targeting each subclass, then reaggregating these subsystems. For example, constraints over command effects on the file system are expressible in Hoare-style logical pre- and post-conditions, whereas constraints over inter-process communication (IPC) and other stream contents are expressible in regular languages-offering benefits in computational tractability, succinctness, and familiarity for everyday Unix developers.

A second example disclosed herein includes a “trust, but verify” approach including leveraging large-language models (LLMs) to translate documentation, a source for black-box commands, into partial specifications, then interposing on commands to test the specifications. For example, the effects of a specific command invocation to the file system may be inferable from its manual (MAN) page and checkable via file system containment and system-call tracing.

A third example disclosed herein is a “better late than sorry” approach. An ahead-of-time check may be insufficient to conclude safety, and in such implementations, specification-aware runtime monitoring can be implemented to stop execution before catastrophic bugs occur. A monitor may be used to halt the execution of a script about to perform a dangerous action going against key invariants.

In one aspect, the present disclosure provides a method for analyzing a Unix shell program. The method includes obtaining a shell script; generating constraints on program state performing symbolic execution of the shell script according to shell semantics and propagating the constraints across a plurality of possible execution paths; performing command specification inference for one or more commands invoked by the shell script and transforming the constraints during the symbolic execution; and determining, based on the propagated and transformed constraints, whether execution of the shell script can violate a safety property associated with an execution environment, and outputting an indication of safety or unsafety of the Unix shell program.

In aspects of the current embodiment, generating constraints on program state includes generating constraints on at least one of environment variables, command arguments, or a working directory, wherein at least a portion of the constraints are represented using regular languages.

In aspects of the current embodiment, at least one command specification inference is based on a precondition and a postcondition of a constraint. In aspects of the current embodiment, the safety property includes preventing deletion of files or directories outside of a permitted region of a file system. In aspects of the current embodiment, performing symbolic execution comprises expanding parameters, tracking working directories, and exploring both success and failure outcomes of at least one command.

In aspects of the current embodiment, the method further includes disaggregating the analysis into a plurality of subsystems corresponding to distinct subclasses of static guarantees and aggregating outputs of the subsystems to produce the indication of safety or unsafety.

In aspects of the current embodiment, the subclasses include one or more of file system effects expressed using preconditions and postconditions or stream content constraints expressed using regular languages.

In aspects of the current embodiment, performing command specification inference comprises inferring a specification of a black-box command using documentation and instrumented probing performed ahead-of-time to generate a specification library.

In aspects of the current embodiment, the method further includes determining compatibility between commands in a pipeline by comparing regular-language constraints associated with outputs of preceding commands and inputs of subsequent commands.

In aspects of the current embodiment, the method further includes, in response to determining that the constraints are insufficient to conclude safety, deploying runtime monitoring configured to halt execution of the shell script upon detecting a violation of an invariant.

In a second aspect, the present disclosure provides Another example embodiment includes:

A system for analyzing a Unix shell program. The system includes one or more processors, and memory storing instructions that, when executed by the one or more processors, cause the system to: obtain a shell script; generate constraints on program state; perform symbolic execution of the shell script to propagate the constraints across a plurality of execution paths; apply command specifications to transform the constraints during the symbolic execution; and determine, based on the propagated and transformed constraints, whether execution of the shell script can violate a safety property and output an indication of safety or unsafety.

In aspects of the current embodiment, to generate constraints on program state, the instructions, when executed by the one or more processors, cause the system to generate constraints on at least one of environment variables, command arguments, or a working directory, wherein at least a portion of the constraints are represented using regular languages. In aspects of the current embodiment, at least one command specification is based on a precondition and a postcondition of a constraint.

In aspects of the current embodiment, the instructions, when executed by one or more processor, cause the system to prevent unsafe file system operations by identifying command invocations having arguments that resolve to unsafe paths.

In aspects of the current embodiment, the instructions, when executed by one or more processors, cause the system to implement symbolic execution that tracks parameter expansion, working directory changes, and branching execution paths.

In aspects of the current embodiment, the instructions, when executed by one or more processors, cause the system to infer specifications of black-box commands using documentation mining and instrumented execution to produce a specification library.

In aspects of the current embodiment, the instructions, when executed by one or more processors, cause the system to use a large-language model constrained by a domain-specific language to derive valid command invocation syntax for the command specifications.

In aspects of the current embodiment, the instructions, when executed by one or more processors, cause the system to analyze pipelines of commands by determining whether output constraints of a first command are compatible with input constraints of a second command.

In aspects of the current embodiment, the instructions, when executed by one or more processors, cause the system to disaggregate the analysis into a plurality of subsystems corresponding to distinct subclasses of static guarantees and aggregating outputs of the subsystems to produce the indication of safety or unsafety.

In aspects of the current embodiment, the instructions, when executed by one or more processors, cause the system to deploy runtime monitoring configured to halt execution of the shell script upon detecting a violation of a specification when static analysis is inconclusive.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a diagram of the core of a Steam updater bug, according to an example embodiment of the present disclosure.

FIG. 2 is a diagram showing a first example fix to the Steam bug of FIG. 1, according to an example embodiment of the present disclosure.

FIG. 3 is a diagram showing a second example fix to the Steam bug of FIG. 1, according to an example embodiment of the present disclosure.

FIG. 4 is a diagram showing command specification inference, according to an example embodiment of the present disclosure.

FIG. 5 is a diagram showing a third example fix to the Steam bug of FIG. 1, according to an example embodiment of the present disclosure.

FIG. 6 provides a flow diagram of a method for performing safety analysis of Unix shell scripts, according to an example embodiment of the present disclosure.

FIG. 7 is a high-level block diagram of an example system for performing the methods described herein, according to an example embodiment of the present disclosure.

### DETAILED DESCRIPTION

The terms “a,” “an,” “the” and similar referents used in the context of describing the invention (especially in the context of the following claims) are to be construed to cover both the singular and the plural, unless otherwise indicated herein or clearly contradicted by context.

All methods described herein can be performed in any suitable order unless otherwise indicated herein or otherwise clearly contradicted by context.

The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

The terms “comprise”, “comprises”, “comprised” or “comprising”, “including” or “having” and the like in the present specification and claims are used in an inclusive sense, that is to specify the presence of the stated features but not preclude the presence of additional or further features.

Methods, systems, and apparatus are disclosed herein for the static analysis for Unix shell programs. Static analysis may be useful for improving the safety and correctness of shell scripts. The benefits of the disclosed systems and methods include fast pre-execution checks for computations that typically takes days, detection of misbehaviors by a script developer and not a user, improved error messages, whole-program optimization opportunities, and elimination of entire classes of bugs. Well-typed shell programs typically may not include many bugs, yet the shell is uniquely challenging when it comes to anything static. The shell's pervasive dynamicity (e.g., runtime evaluation, expansion, subshells) may make ahead-of-time checking of code and bugs intractable. Shell programming's tight integration with, and arbitrary effects on, broader environments complicates reasoning about possible states and effects prior to program execution. Additionally, its black-box, polyglot commands occlude deep reasoning. Due to such complications and complexities, the shell, the oldest and most prevalent environment today, still relies on surface-level syntactic linting (e.g., via ShellCheck). In the face of these challenges, the methods and systems described herein provide ahead-of-time to just-in-time analysis to enable shell rehabilitation.

Examples disclosed herein can mitigate and otherwise work with some of the difficult aspects of a programming shell (e.g., arbitrariness, dynamicity, obscurity), and may further reduce or eliminate errors and error proneness of shells. The described examples also provide additional opportunities for improving correctness and reliability, not only benefiting the shell, but also other prominent virtualization, containment, and cloud environments wrapping shell constructs.

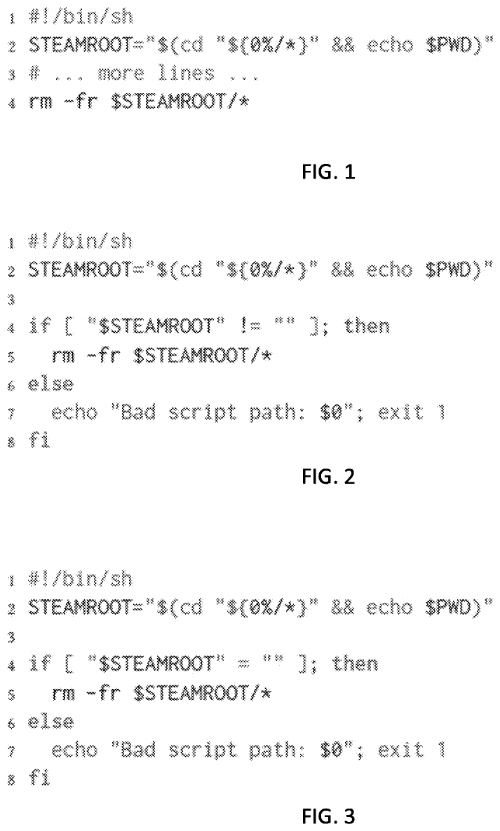

FIG. 1 shows a core of a bug in a Steam-for-Linux updater, which wiped file systems of many Steam users. FIG. 1 shows that when expansion results in an empty STEAMROOT string, line 2, the script deletes everything user-writable, line. 4. FIG. 2 shows a safe fix to the Steam bug of FIG. 1, whereby the “rm -fr” line will never take an empty string, guaranteed across all executions and environments. FIG. 3 shows an almost identical but unsafe fix to the bug of FIG. 1 whereby a small syntactic mistake carries significant weight. In FIG. 3, the “rm -fr” line will always delete everything user-writable. As such, the updater first deletes the current version of the program, the location of which it identifies via a variable STEAMROOT. The value of the variable is determined using runtime expansion, all in a subshell: identify the path of the current script ($ {0}), expand it to remove anything after the last slash (%/*), change to that path (cd . . . ), and report the current directory ($PWD). For some paths (e.g., ~/.steam/upd.sh), expansion results in the parent directory as intended (e.g., /home/jcarb/.steam); for other paths (e.g., ones lacking any directories like upd.sh), expansion results in the script name, causing cd to fail and STEAMROOT to end up empty. The result: “rm -fr/*” then deletes everything user-writable on the system. Such an error causes massive disruptions to files and systems.

Some work has studied interactions of individual commands with an environment, not larger-scale program composition, or it focuses on a single composition primitive (e.g., represented by the operator|). Tools such as ExplainShell, offer help with command invocations, but do not check correctness.

The most widely used tool is ShellCheck, a syntactic linter based on a collection of hard-coded patterns (e.g., proper variable names). ShellCheck is used by about 65% of top GitHub shell repositories with over 1K shell lines of code (LoC), indicating a community need for static shell-script analysis. When run on the code of FIG. 1, the ShellCheck linter issues a warning for suggesting replacing $STEAMROOT with “${STEAMROOT:?}” to signal a runtime error when the variable is empty. Unfortunately, this kind of syntax-matching approach is limited as it fails to recognize an obviously safe fix (e.g., as shown in FIG. 2) and it fails to identify the unambiguous incorrectness of an obviously unsafe fix (e.g., as shown in FIG. 3). As it should be noted, the safe and unsafe fixes, differ by only one character. Surface-level syntactic linting is inherently noisy and context-insensitive, which may result in unsafe, or further undesirable operations being approved by such linter approaches.

Performing deep reasoning about semantics at the scale and complexity of real shell programs requires several key factors. Firstly, a static analysis system for the shell must first be able to understand and reason about the state of the shell and its broader environment (e.g., the file system, command arguments, and environment variables). The first consideration is therefore to track and generate relevant constraints on state. To identify a bug such as in FIG. 1 and recognize its absence in the code of FIG. 2, the analysis needs to generate constraints for all variables and their contents. Examples of such variables include FIG. 1's $0 and $PWD, which the contents may be file or directory paths. Existing, well understood, and tractable formalisms, like regular expressions, can be used to describe such constraints, e.g., file paths can be described by a regular expression of the form /?([\hat{ }/]*/)*[\hat{ }/]+. Such formalisms offer several benefits including computational tractability and ease-of-use for developers versed with the expressions found pervasively in a Unix environment.

Second, a static analyzer should be able to reason about how the aforementioned state is transformed by an arbitrary piece of shell code such as composition primitives, subshells, expansion, and built-ins. As such, another ingredient is symbolic execution, simulating the actions of the shell interpreter, symbolically describing the results of operations and transforming sets of program states along the way. The symbolic engine implements the semantics of the shell language, including composition primitives such as |, &, and &&. It also models the behavior of key built-in commands, such as cd and [, analogously to primitive functions in other programming languages. During symbolic execution, the engine expands parameters, tracks working directories, follows success and failure paths collecting and propagating constraints on symbolic variables and pruning via concrete state whenever possible.

For example, given that the possible contents of $0 expand to either a directory or a filename, cd will either (1) change the program's current directory to a directory, print no output, and succeed, or (2) fail with output on stderr but not stdout. The engine will explore both executions and symbolically exit the subshell with two potential results. Upon conclusion, it will issue a warning for one of the two execution paths that results in rm -fr/*.

A third consideration includes inferring command specifications. The analysis of the shell depends on specifications of commands such as cd and rm, and their specific invocations such as rm -fr. Commands are fundamentally black-box, written by different developers and in arbitrary languages, often distributed as binaries, and equipped with a multitude of configuration flags and system-specific variations. Conventional program analysis techniques therefore face immense hurdles for inferring their specifications.

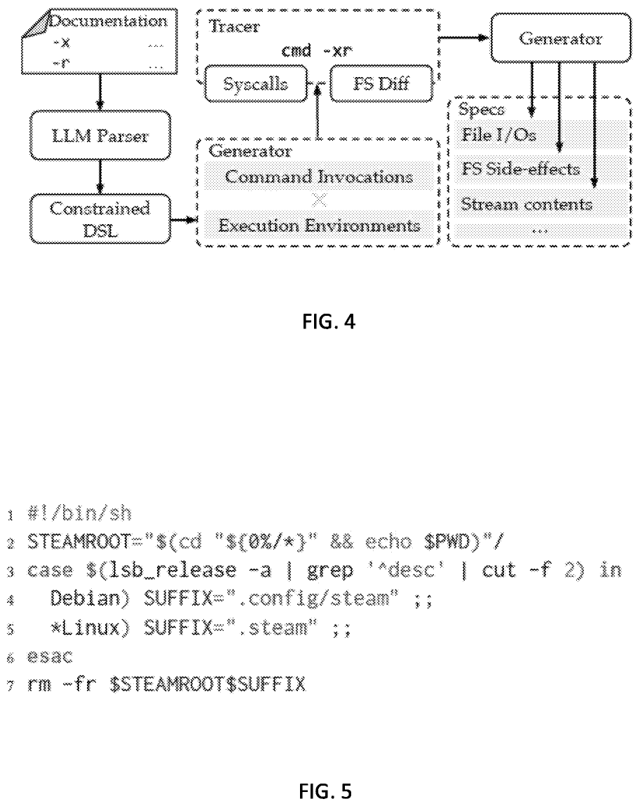

Fortunately, commands are typically distributed with some form of documentation. Thus, another ingredient is documentation mining with instrumented probing applied ahead-of-time to build a queryable specification library accompanying the analysis engine. FIG. 4 shows block diagram flowchart of a command specification inference, according to an example embodiment disclosed herein. On the left in FIG. 4, all valid invocations of a command are generated by guardrailing a tuned LLM using domain-specific language that allows only valid invocations. In the middle of FIG. 4, all command invocations in a set of execution environments are instrumented and executed confirming their effects. On the right of FIG. 4, the effects to specifications are compiled, targeting key classes of constraints.

The first step illustrated in FIG. 4 derives a command's invocation syntax using its natural language documentation (e.g., man pages, markdown files, web pages, etc.). The syntax derivation leverages an LLM guardrailed through a domain-specific language designed to express only legitimate invocations satisfying common utility conventions such as the XBD standard. Using the syntax specification, the miner generates a large number of test configurations sweeping through the possible flags, options, and relevant file system states. It then instantiates concrete environments, executing each command configuration with appropriate interposition to record all of its interactions within each environment. Finally, it examines the traces extracted by the concrete executions and applies a series of transformation rules to produce the final specifications.

The described methods and procedures lead to a precise and accurate specification, expressed as Hoare triples, (e.g., preconditions, command invocation, and postconditions). Such an implementation is an example of disaggregating the total analysis of the shell into a plurality of subsystems with distinct subclasses of static guarantees. For instance, for rm -fr: the man -driven, LLM-assisted derivation generates a syntax specification that includes (1) -r and -f as distinct, non-exclusive flags, and (2) at least one positional argument to rm as a path, examples to multiple subsystems for analysis. It then generates all valid invocations, including rm {, -f, -r, -f -r} $p, along with appropriate environments for probing each invocation's effects including cases where $p is a file, a directory, or nothing existent. By instrumenting execution during probing, it is discovered that given a path to an extant directory, rm-f-r $p deletes that directory and exits with code 0 by

{ (∃ $p ) Λ (arg 0 $p path.FD) }
rm −f −r $p
{ ( [symbol] $p ) Λ exit 0 }

That is, when the -r and -f flags are present and the first positional argument is a path to a file or directory, then the file or directory is deleted, and the exit code is 0. The various results may then be reaggregated based on the various subsystems generated. Further, determinations of the safety of the shell may be based on individual results of the various subclasses (e.g., invocations) or on the aggregation of potential outputs, (e.g., exit code, resultant deletion of directories or data, etc.).

The described systems and methods also perform reasoning about stream contents. The analysis also reasons about the contents of Unix streams and files. FIG. 5 shows another fix to the bug of FIG. 1 whereby the grep ‘\hat{ }desc’ filter is mistaken, allowing no content to pass through, causing the fix to never apply. FIG. 5 provides an example of implementing stream reasoning. The code of FIG. 5 appends STEAMROOT with a platform-dependent subdirectory. The output of LSB_release -a, lines of label-value pairs separated by tabs, is filtered first by grep to select a line with a matching label, and then by cut to extract the second field. In FIG. 5, ‘\hat{ }desc’ should have been ‘\hat{ }Desc’; and as such, grep produces no output and the suffix is never set, leaving the script vulnerable to the same bug.

Therefore, encoding the shape of streams requires another element, regular languages, a familiar and concise representation for string shapes. The languages can equivalently describe the shape of entire streams or, often more conveniently, the shape of each line in the stream. A possible way, among many, to specify the output of lsb_release -a is:
(Distributor ID|Description|Release|Codename):\t.*

In turn, specifying that the grep of FIG. 5 accepts any input and produces output beginning with desc amounts to the following summary in the style of a type signature:
grep ‘\hat{ }desc’::.*→desc.*

Straightforward reasoning shows that the intersection of grep's combined input, from lsb_release, and output constraints is the empty language, thus always resulting in the default (empty) case.

As described above, the proposed approach (1) performs an analysis entirely statically well before the execution of a program, (2) stems from reasoning about the semantics of the shell and the components involved in a program, and (3) provides guarantees about all possible executions, not just a subset of executions.

In contrast to other approaches, the disclosed systems and methods are context sensitive, and conclude safety or unsafety by tracking constraints on variable contents, including those from conditionals. Further, the methods and systems are robust to semantically-equivalent syntactic variants such as splitting rm's path across variables such as
c=“/*”; rm -fr $STEAMROOT$c

The various considerations and elements described for the disclosed methods and systems offer conclusive results on provided examples. Additional complexities may arise in practice such as file system effects. Diagnosing dangerous file deletions is an important benefit of the proposed analysis, but precise reasoning could detect and prevent even finer-grained file manipulation bugs. By augmenting the symbolic execution engine, the analysis can track constraints on the nodes in the file system to which individual paths resolve. When competing constraints are inconsistent, the system determines that the script contains a bug arising from command composition.

As an example, consider the lines below:

rm −r “$1”
cat “$1/config”

By symbolically modeling the state of the file system, as described herein, the analysis determines that, after the invocation of rm, the file or directory to which $1 resolved no longer exists. The invocation of cat introduces a constraint that $1/config resolves to a file. To resolve this path, however, $1 must resolve to a directory with a file entry named config, and the directory does not exist, and as such, the system issues a warning that the invocation will always fail.

While such bugs may seem trivial at the surface, they easily become subtle as multiple control paths, variables containing arbitrary paths, and path aliasing come into play. Buggy compositions may be split across hundreds of lines of code and arise only under specific conditions. This happens with a symbolic execution that simultaneously considers all possible executions. The central challenge is to track the file system's state with sufficient precision as to enable useful reasoning whilst avoiding exponential explosion in complexity for realistically sized programs.

Another potential complexity includes environment and runtime monitoring. Inference of stream and file contents faces precision limitations, and therefore might at times fail to produce a type for a command. Addressing such limits, without risking safety and when user annotations are not available, requires runtime monitoring. When enabled, runtime monitoring protects computations adjacent to an untyped command to ensure their type expectations are maintained during the execution of the program. Such monitoring is achievable with a higher-order monitor command, that monitors a command's input and output streams to ensure they conform to the specification inferred by adjacent commands. The cost of maintaining safety without annotations is monitoring overhead and delayed error detection which are trade-offs similar to gradual types.

Another challenge arises in performing ergonomic annotations. Retrofitting existing shell interpreters with an elaborate stream type system requires large amounts of engineering effort, drastic changes to syntax and semantics, and break backwards-compatibility. In order to avoid such issues and maintain full compatibility with existing shell interpreters, the constraints can instead join the shell ecosystem through annotations manifesting as inline comments or external files. This would also allow developers to examine, interact, and produce new constraints as they see fit or are required.

The confidence of non-expert annotations can be improved by levering instrumented probing, injecting runtime monitoring, or building a community-sourced repository of annotations (e.g., via TypeScript). But dealing with raw constraints is intimidating and cumbersome. Alleviating such a challenge requires offering focused support for constraints, including an extensible library of descriptive types. For example, “any” may stand for. *; url for inputs to “curl” and “longlist” for outputs of ls -l. Other support includes type introspection via shell utilities such as typeOf, type definitions and abstractions, and tight integration with dynamic monitoring infrastructure. Such support simplifies development, improves precision and performance, and results in more descriptive error messages.

Simple regular language types do not always preserve information across stages. Considering the pipeline provided below, which extracts hexadecimal numbers, then prefixes every number with 0x, and finally sorts them.

hex=‘[0-9a-f]+’
grep −oE $hex |
sed ‘s/\hat{ }/0x/’|
sort −g

Simple types for the first two stages are:

grep −oE $hex :: .* → [0-9a-f]+
sed ‘s/\hat{ }/0x/’ :: .* → 0x.*

These two types alone are unable to establish that the input of sort -g falls under 0x[0-9a-f]+.*, because the type of sed fails to propagate the fact that each 0x prefix is followed by a hexadecimal number. Polymorphic types may be used to remedy this limitation. Polymorphic types offer expressiveness that allows a single abstract type to be parameterized over one or more constituent types. For example, when every input line of sed ‘s/\hat{ }/0x/’ satisfies a, then every output line satisfies 0xα:
sed‘s/\hat{ }/0x/’::∀α. α→0xα

Similarly,
sort -g::∀αa. 0x[0-9a-f]+α→0x[0-9a-f]+α
   Correctness is confirmed by (1) unifying sed's output 0xα with sort's acceptable input 0x[0-9a-f]+.* to obtain [0-9a-f]+.* (denoted Σ), and (2) confirming that grep's output is compatible with sed, i.e., that [0-9a-f]+⊆Σ.

The methods may further implement feedback loops and circular dataflow to improve performance. Complex patterns of interprocess communication in a shell are increasingly prevalent. Typical workloads such as crawlers and indexers feature circular dataflow structures, but the rise of machine-learning workloads may benefit from use of feedback loops and backpropagation edges. These structures complicate type constraint propagation, requiring potentially challenging fixpoint reasoning. Establishing correctness in such implementations requires reasoning about stream invariants (e.g., properties preserved by the entire cycle). Worst-case invariant discovery for circular streams can be difficult, but real scripts require invariants simple enough to be computed with an iterative “least fixpoint” approach, such as start with an empty invariant set and then gradually expand the set until a property needs no further expansion. Such an approach may be performed and implemented due to the semantics of cat or tail-f typically at the beginning of such cycles.

Building a robust infrastructure tackling the challenges of shell programming and shell programs, as described, additional may allow for improvements in future research and applications. Early detection of potential incorrectness is not limited to the script itself but can be extended to incompatibilities with an execution environment. For example, a script might be written on a developer environment running Mac OS X but might end up deployed on cloud infrastructure running Linux. Given the capability to perform static reasoning, the analysis can trivially also identify and warn developers before distribution about platform-dependent code, and even automatically transform the program to equivalent variations for different platforms.

Besides identifying potential errors, static analysis can be leveraged to automatically insert fixes targeting correctness. Such fixes might include synthesized dependency prologues that ensure that a script's dependencies are met, including expected file system state, available utilities, and shell environment. With integration into IDE tooling, developers could also receive tailored suggestions that guarantee protection against identified bugs. Furthermore, the described benefits naturally extend to other systems that serve as thin shell wrappers, like Dockerfiles.

Infrastructure for ahead-of-time semantics-driven analysis can also offer significant security benefits. One possibility enabled by the described analysis infrastructure is checking scripts against user-defined specifications capturing properties beyond crashes or catastrophic system effects, which might even be context-dependent. Consider for example the unfortunately-not-uncommon curl-to-sh software installation method, which instructs users to download and execute an installer script with a line of code:
curl software.com/install.sh|sh

A reasonable security-conscious user may wish to confirm that the install script does not read or modify personal files. With a configurable specification verifier, and perhaps a library of commonly-used property definitions, a user may execute code to ensure the installer script behaves as expected, such as:

curl software.com/install.sh |
verifysh no-read-write ~/myfiles | sh

Such a verification tool could verify as much as possible statically, and then leverage the guard and monitor generation mentioned above to fill gaps or address reasoning challenges in static verification, ensuring security.

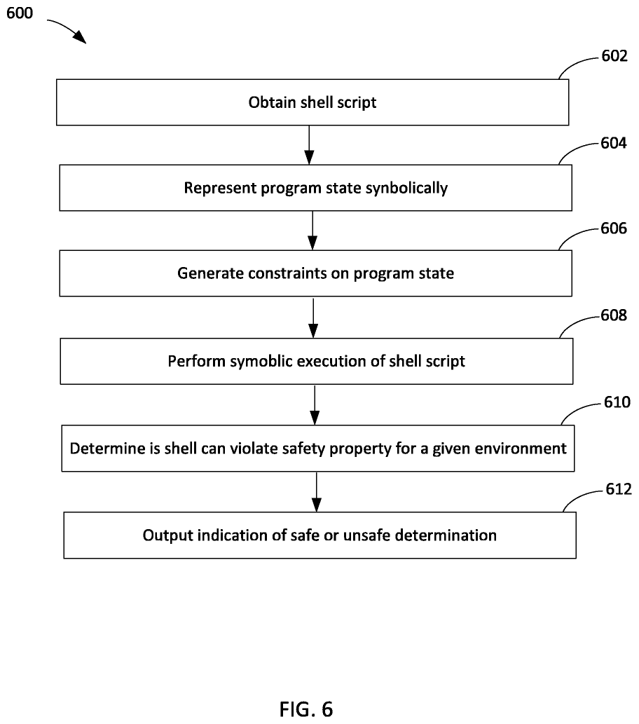

FIG. 6 provides a flow diagram of a method 600 for analyzing and performing safety analysis of Unix shell scripts according to examples provided herein. At block 602, a shell script is received, and an analysis environment is initialized. The shell script may be provided by a user, obtained from a memory, retrieved from a network, etc. At block 604, the system represents program state using symbolic variables. The system represents a program state using symbolic variables corresponding to execution-relevant components of the shell environment, which may include a working directory, command arguments, and environment-variable contents. The symbolic representation enables reasoning about multiple potential executions.

At block 606, the method generates constraints over the symbolic variables. The constraints may be expressed using multiple complementary formalisms. For example, file system effects may be modeled using logical preconditions and postconditions, while stream content constraints may be expressed using regular languages. Such dual representation allows the method to capture both structural properties of file system interactions and shape-based properties of inter-process data streams.

At block 608, the method performs symbolic execution that simulates the semantics of a shell interpreter. The symbolic execution may include parameter expansion, updates to the working directory, and exploration of branching behavior corresponding to success and failure outcomes of commands (e.g., successful execution and proper function of a command or shell, of failure to execute the commands properly, or perform undesirable functions such as delete unintended files or data, etc.). The described semantic simulation enables the disclosed method to accurately model real execution behavior, including subtle interactions across commands. Additionally, command specifications are applied during symbolic execution. The specifications may include preconditions and postconditions capturing the effects of command invocations, particularly with respect to file system state. The command specifications are used to transform constraints during execution, enabling accurate modeling of command-induced state changes even where commands are treated as black-box components.

In examples, the constraints may be propagated along multiple symbolic execution paths. The system evaluates feasible execution paths by maintaining and updating constraints across branching conditions, allowing the method to simultaneously reason about all possible executions rather than a single runtime instance. This allows the disclosed methods to identify multiple safe and potentially unsafe implementations of the Unix code in an environment, or across different environments.

At block 610, the system determines when any execution path violates a safety property of an environment. Such safety properties may relate to file system integrity (e.g., preventing unintended deletion of critical directories), to correctness of inter-process communication streams (e.g., preventing incompatible data transformations), access to restricted or undesirable locations, etc. The determination is based on the propagated constraints and reflects a semantics-driven understanding of the script behavior.

At block 614, when a violation is detected, the method may halt execution of the shell to prevent potential damage to data, a system, or loss of information or other undesirable behavior or result. Additionally, the system may be configured to output a warning or indication of the potential error or unsafe behavior. The warning may identify a specific execution path that leads to the violation, thereby enabling targeted debugging and remediation. Conversely, when no violation is found, the method outputs an indication that the safety properties are not violated and are preserved across all analyzed execution paths.

Whole-program performance optimizations for shell scripts show great promise. Such optimizations include shell script or command elision, parallelization, fusion, and various forms of distribution. With rich static information, such optimizations can be improved by reducing the need to discover and reason about the optimization dynamically. As a concrete example, shell state and file system reasoning can identify read-write dependencies between commands in a script, which would enable the hS speculative execution system to reorder commands without needing to guard against misspeculation and reduce the runtime tracing overhead of incremental execution systems like Riker.

Ahead of time analysis can be used to bring the benefits of shell optimization systems to users without asking or requiring a user to replace a shell or change how a user run scripts. A static optimization engine can serve as the backbone for a suggestion-based optimization coach that, like ShellCheck, can be integrated tightly with IDE tooling or even be available via a webpage.

The described systems and methods aimed to deliver correctness guarantees for computing systems was implemented given specific examples. Modern computing infrastructure remains heterogeneous and legacy systems are pervasive. The shell's continued prevalence is explained in great part by the role it plays in bridging the gap between these heterogeneous systems, where it is a key element in that domain.

Some use-cases may benefit from replacing a shell with more tailored workflow languages, but the fundamental challenges of bridging the gap are not particular to the language. The benefits to be found from seriously tackling correctness for the shell apply to all systems that bridge such a gap, including, e.g., Docker, Ansible, CI/CD, etc., Heterogenous system orchestration, composition, and installation does not need to be a trouble spot that wastes developer time and causes mysterious or hard to identify bugs. The series of benefits, systems, and methods described herein demonstrate the feasibility of building robust tooling for the shell.

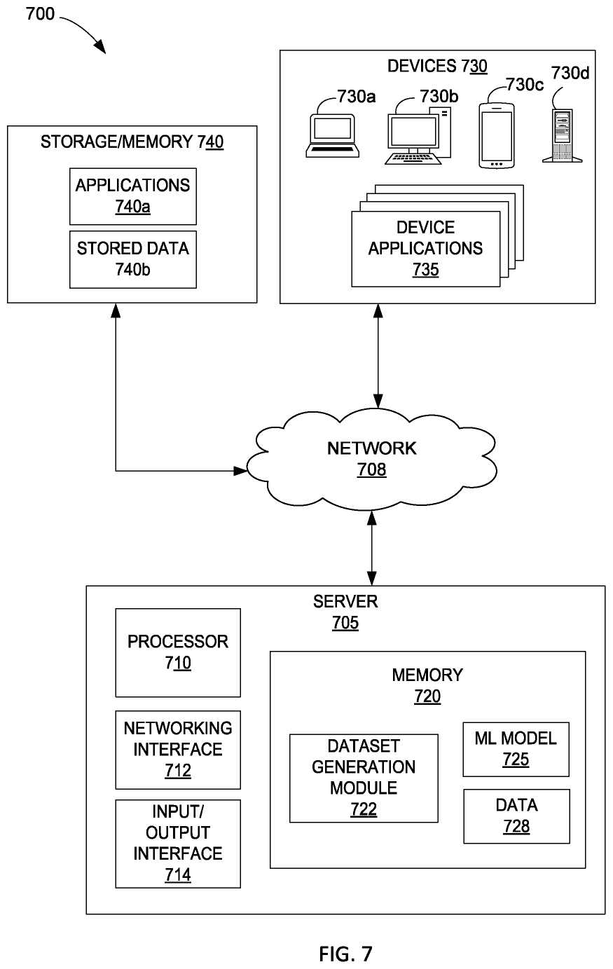

FIG. 7 is a high-level block diagram of an example system 700 for performing the methods described herein. The various elements of the example system 700 include hardware and software components that may be used to analyze a Unix shell and determine potential safety violations, as described herein. The example system 700 may include a server 705, one or more devices 730, and a memory 740. The server 705, devices 730, and memory 740 communicate or transmit information and data via one or more networks 708. Each of the devices 730, memory 740, and server 705 may include processors, onboard memory or storage, a display screen, input devices (e.g., keyboards, touch screens), and other hardware for executing software or processes, storing data, receiving user inputs, and/or displaying information. In an implementation, the server 105 may be a cloud-based server.

The devices 730 may include one or more client devices or user devices, such as a laptop 730a, a desktop computer 730b, or a smartphone 730c. The devices may include additional servers 730d, workstations, platforms, network hosts, mobile devices, or any processor or computational device that may execute computer-readable instructions or store data thereon. Each of the devices 730 may include one or more programs or applications 735 that one or more processors may execute. The one or more programs or applications may include Unix shells for execution. The applications 735 may include consumer applications, such as games, shopping applications, or applications that control machinery or devices, or other additional applications.

The devices 730 are connected to the server 705 via the network 708. The server 705 may communicate with the devices 730 to cause the devices 130 to execute one or more applications (e.g., to perform a self-scan, to update software, perform an analysis of Unix shell, etc.), and the server 705 may store or retrieve data from the devices 730 via the network 708. Additionally, the devices 730 may transmit a command or request for services or data to the server 705 via the network 708. For example, one or more of the devices 730 may request an analysis of a Unix shell via the network 708, and the server 705 may initiate an analysis for a Unix shell according to the requested device or application.

Broadly, the server 705 and/or devices 730 may initiate a task, and provide a task file to a processor (e.g., the processor 710, one of the devices 730) to perform any of the methods or processes described herein. In implementations, the task file may be a JavaScript Object Notation (JSON) representation/data format of the one or more task scripts transferable from the server 705 to a device 730 or vice versa. The task file may further be loadable/readable by a C++ runtime engine, or other suitable runtime engine, executing on the processor 710 or on one of the devices 730.

The memory 740 may include, without limitation, cloud storage, databases, applications, APIs, the Internet of Things storage, hard disk drives, solid state drives, etc. In an implementation, the memory 740 may store/host applications 740a associated with one or more of the devices 730. In an example of a banking institution, the memory 740 may be cloud-based storage, and the cloud storage may host banking applications that are operated and utilized by end users of a banking institution, e.g., the end user operating a personal device, such as smartphone 730c, may utilize the banking application hosted on the cloud-based storage. The memory 740 may further store data 740b, which may include user credentials, documents, images, or any other types of files and data required for the applications 740a, required by the devices 730, or used or stored by the server 705.

The server 705 includes a processor 710 that may execute machine-readable instructions. The processor 710 may perform functions and operations for performing analysis and safety determination of Unix shells as described herein. The processor 710 may further perform operations for generating training data, training a ML model, and utilizing the trained ML model to perform analysis of Unix shells. The ML model 725 may include an NLP or another type of ML model or algorithm for performing the operations and methods described herein.

The processor may execute one or more applications stored on a memory 720 of the server, or the processor may execute machine-readable instructions and applications stored on external storage or memory (e.g., the memory 740 via the network 708). It should be understood that one or more of the operations described herein may be performed by external hardware other than the server 705. For example, one or more of the devices 730 may perform one or more processes or steps of the described methods. Together, the server 705 and additional hardware may perform the disclosed methods. For simplicity and to provide an example, a processor, such as the processor 710 of the server 705, or a processor of one of the devices 730, will be described as performing the methods described herein. The server 705 may be implemented as one or more cloud-based servers, such as a cloud-based computing platform. For example, the server may be any one or more cloud-based platform(s), such as Microsoft Azure, Amazon AWS, or the like.

The server memory 720 may store computer-executable instructions to cause the system 700, or a device of the system (e.g., server 705, processor 710 of the server 705, device 730, etc.) to perform one or more of the steps of the methods described herein. The memory 720 may store one or more ML modals to perform one or more steps of the methods described herein. The data 728 stored on the server memory 720 may include information regarding one or more workstations, platforms, or network hosts, such as configuration settings, patch history, performance data, user data, etc. The server 705 may perform scans and perform analysis of hardware and applications (e.g., Unix shells) via the network 708, and the server 705 may store data indicative of past analyses, erroneous configurations, potential safety issues, safety properties of a system or environment, Unix shell code, etc. In any implementation, the server 705 may perform analysis of Unix shells to determine safe or unsafe possible execution paths associated with any device 730 and/or device applications 735, or other hardware or software.

Each of the storage/memory 740 and the server memory 720 may include one or more forms of volatile and/or non-volatile, fixed, and/or removable memory, such as read-only memory (ROM), electronic programmable ROM, random-access memory (RAM), erasable electronic programmable ROM, and/or other hard drives, flash memory, MicroSD cards, and others. In general, a computer program or computer-based product, application, or code (e.g., other computing instructions described herein) may be stored on a computer-usable storage medium or tangible, non-transitory computer-readable medium (e.g., standard RAM), an optical disc, a universal serial bus (USB) drive, or the like, having such computer-readable program code or computer instructions embodied therein, wherein the computer-readable program code or computer instructions may be installed on or otherwise adapted to be executed by the one or more processors 710 of the server 705 or devices 730 (e.g., working in connection with the respective operating system (OS) in the memories 740, 720) to facilitate, implement, or perform the machine-readable instructions, methods, processes, elements, or limitations, as illustrated, depicted, or described for the various flowcharts, illustrations, diagrams, figures, and/or other disclosures herein. In this regard, the program code may be implemented in any desired program language, and it may be implemented as machine code, assembly code, byte code, interpretable source code, or the like (e.g., via Golang, Python, C, C++, C#, Objective-C, Java, Scala, ActionScript, JavaScript, HTML, CSS, XML). Additionally, the memories 140, 120 and the devices 130 may store an OS (e.g., Microsoft Windows, Linux, Unix) capable of facilitating the functionalities, apps, methods, or other software as discussed herein.

The one or more processors 710 may be connected to the one or more memories 720 via a computer bus responsible for transmitting electronic data, data packets, or other electronic signals to and from the one or more processors 710 and the one or more memories 720 to implement or perform the machine-readable instructions, methods, processes, elements, or limitations, as illustrated, depicted, or described for the various flowcharts, illustrations, diagrams, figures, and/or other disclosures herein. The processor 710 may interface with the server memory 720 via a computer bus to execute an OS and to create, read, update, delete, or otherwise access or interact with data stored in the server memory 720.

The server 705 further includes a networking interface 712 and an input/output interface 714. The networking interface 712 may be configured to communicate (e.g., send and receive) data via one or more external/network port(s) or one or more networks or local terminals, such as the network 708, described herein. In some embodiments, the networking interface 712 may include a client-server platform technology, such as ASP. NET, Java J2EE, Ruby on Rails, Node.js, a web service, or online API, responsible for receiving and responding to electronic requests. The networking interface 712 may implement client-server platform technology that may interact, via the computer bus, with the memory 720 (including application(s), component(s), API(s), data, Unix Shells, etc., stored therein) to implement or perform the machine-readable instructions, methods, processes, elements, or limitations, as illustrated, depicted, or described for the various flowcharts, illustrations, diagrams, figures, and/or other disclosures herein.

The networking interface 712 may include, or interact with, one or more transceivers (e.g., WWAN, WLAN, and/or WPAN transceivers) functioning in accordance with Institute of Electrical and Electronics Engineers (IEEE) standards, Third Generation Partnership Project standards, or other standards, and that may be used in receipt and transmission of data via external/network ports connected to the network 708. In some embodiments, the network 708 may include a private network or local area network. Additionally, or alternatively, the network 708 may comprise a public network, such as the Internet. In some embodiments, the network 708 may comprise routers, wireless switches, or other such wireless connection points communicating to the server 705 (via the networking interface 712) and the devices 730 (via respective networking interfaces of the devices 730) via wireless communications based on any one or more of various wireless standards, including by non-limiting example, IEEE 802.11a/b/c/g (a Wi-Fi standard), the Bluetooth standard, or the like.

The input/output interface 714 may include or implement operator interfaces configured to present information to an administrator or operator and/or receive inputs from the administrator or operator. An operator interface may provide a display that a user/operator may use to visualize any graphics, text, data, images, features, pixels, and/or other suitable visualizations or information. For example, the server 705, or one of the devices 730, may comprise, implement, have access to, render, or otherwise expose, at least in part, a graphical user interface (GUI) for displaying graphics, text, data, images, features, pixels, and/or other suitable visualizations or information on the display screen. The input/output interface 714 may also include input/output components (e.g., ports, capacitive or resistive touch-sensitive input panels, keys, buttons, lights, LEDs, any number of keyboards, mice, USB drives, optical drives, screens, touch screens), which may be directly/indirectly accessible via or attached to the server 705. According to some embodiments, an administrator or user/operator may access the server 705 to construct tasks, analyze vulnerability scan data or other information, make changes, input responses and/or selections, and/or perform other functions. Each of the devices 730 may additionally include one or more input/output interfaces, such as keyboards, touch screens, microphones, displays, etc.

While described with respect to specific implementations and examples, it should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A method for analyzing a Unix shell program, the method comprising:
obtaining a shell script;
generating constraints on a program state related to the shell script;
performing symbolic execution of the shell script according to shell semantics and propagating the constraints across a plurality of possible execution paths;
performing command specification inference for one or more commands invoked by the shell script and transforming the constraints during the symbolic execution;
determining, based on the propagated and transformed constraints, whether execution of the shell script violates a safety property associated with an execution environment; and
outputting a safety or unsafety indication of the Unix shell program.

2. The method of claim 1, wherein generating constraints on the program state includes generating constraints on at least one of environment variables, command arguments, or a working directory, wherein at least a portion of the constraints are represented using regular languages.

3. The method of claim 1, wherein at least one command specification inference is based on a precondition and a postcondition of a constraint.

4. The method of claim 1, wherein the safety property includes preventing deletion of files or directories outside of a permitted region of a file system.

5. The method of claim 1, wherein performing symbolic execution comprises expanding parameters, tracking working directories, and exploring success or failure outcomes of at least one command.

6. The method of claim 1, further comprising:
disaggregating an analysis of the shell script into a plurality of subsystems corresponding to distinct subclasses of static guarantees; and
aggregating outputs of the plurality of subsystems to produce the safety or unsafety indication.

7. The method of claim 6, wherein the plurality of subclasses include one or more of:
file system effects expressed using preconditions and postconditions; or
stream content constraints expressed using regular languages.

8. The method of claim 1, wherein performing command specification inference comprises inferring a specification of a black-box command using documentation and instrumented probing performed ahead-of-time to generate a specification library.

9. The method of claim 1, further comprising determining compatibility between commands in a pipeline by comparing regular-language constraints associated with outputs of preceding commands and inputs of subsequent commands.

10. The method of claim 1, further comprising, in response to determining that the constraints are insufficient to conclude safety, deploying runtime monitoring configured to halt execution of the shell script upon detecting a violation of an invariant.

11. A system for analyzing a Unix shell program, comprising:
one or more processors; and
memory storing instructions that, when executed by the one or more processors, cause the system to:
obtain a shell script;
generate constraints on a program state that is related to the shell script;
perform symbolic execution of the shell script to propagate the constraints across a plurality of execution paths;
apply command specifications to transform the constraints during the symbolic execution; and
determine, based on the propagated and transformed constraints, whether execution of the shell script can violate a safety property and output a safety or unsafety indication.

12. The system of claim 11, wherein to generate constraints on program state, the instructions, when executed by the one or more processors, cause the system to generate constraints on at least one of environment variables, command arguments, or a working directory, wherein at least a portion of the constraints are represented using regular languages.

13. The system of claim 11, wherein at least one command specification is based on a precondition and a postcondition of a constraint.

14. The system of claim 11, wherein the instructions, when executed by one or more processor, cause the system to prevent unsafe file system operations by identifying command invocations having arguments that resolve to unsafe paths.

15. The system of claim 11, wherein the instructions, when executed by one or more processors, cause the system to implement symbolic execution that tracks parameter expansion, working directory changes, and branching execution paths.

16. The system of claim 11, wherein the instructions, when executed by one or more processors, cause the system to infer specifications of black-box commands using documentation mining and instrumented execution to produce a specification library.

17. The system of claim 11, wherein the instructions, when executed by one or more processors, cause the system to use a large-language model constrained by a domain-specific language to derive valid command invocation syntax for the command specifications.

18. The system of claim 11, wherein the instructions, when executed by one or more processors, cause the system to analyze pipelines of commands by determining whether output constraints of a first command are compatible with input constraints of a second command.

19. The system of claim 11, wherein the instructions, when executed by one or more processors, cause the system to disaggregate an analysis of the shell script into a plurality of subsystems corresponding to distinct subclasses of static guarantees and aggregating outputs of the plurality of subsystems to produce the safety or unsafety indication.

20. The system of claim 11, wherein the instructions, when executed by one or more processors, cause the system to deploy runtime monitoring configured to halt execution of the shell script upon detecting a violation of a specification when static analysis is inconclusive.
